(19) United States
(12) Patent Application Publication
(10) Pub. No.: US 2002/0070173 A1
(43) Pub. Date: Jun. 13, 2002

(54) Apparatus and method for use in magnetic separation of magnetically attractable particles in a liquid

(75) Inventors: Paul E. Otto, Madison, WI (US); Steven T. Krueger, Deerfield, WI (US); Michael P. Bjerke, Oregon, WI (US); Julia E. Krueger, Deerfield, WI (US)

Correspondence Address: Grady J. Frenchick, Michael Best & Friedrich LLP, One South Pinckney Street, P.O. Box 1806, Madison, WI, 53701-1806, US

(73) Assignee: Promega Corporation, Madison, Wisconsin

(21) Appl. No.: 09/732,617

(22) Filed: Dec. 8, 2000

(51) Int. Cl. B03C 1/02

(52) U.S. Cl. 210/695; 210/222

(57) ABSTRACT

An apparatus and method for use in magnetic separation of magnetically attractable particles suspended in a liquid. The apparatus includes a magnetic separator plate having a plurality of channels, one for each column of wells of a multi-well assay plate which is received by the magnetic separator plate. A plurality of magnets are positioned in each channel so that when the magnetic separator plate receives the multi-well assay plate, the magnets attract the magnetically attractable particles to create a pellet of material of a substance of interest on a side wall within each associated well.

### FIELD OF THE INVENTION

The present invention relates generally to fluid handling systems which utilize liquid containing wells, such as microtitration plates. More specifically, the present invention relates to an apparatus and method for use in magnetic separation of magnetically attractable particles in a liquid.

### BACKGROUND OF THE INVENTION

Patient health care and biological research have made dramatic improvements in recent years, in part due to the utilization of assay techniques. Laboratory and clinical procedures involving biospecific affinity reactions are commonly employed in testing biological samples, e.g., blood or urine, for the identification and/or quantification of a wide range of target substances, such as particular chemical substances that have been correlated or associated with various disease conditions. The efficiency with which various tests, reactions, assays and the like can be performed in biology, clinical diagnostics, and other areas, has been greatly increased by adoption of parallel sample handling techniques. Specific examples include polymerase chain reaction (PCR) techniques, enzyme-linked immunosorbent assay (ELISA), enzyme immune assay (EIA), radioimmune assay (RIA), membrane capture assays, cell washing, enzyme assays, receptor binding assays, other molecular biological reactions and washes, and the like. In most of these procedures, samples are processed in multi-well microtitration assay plates, although other devices may be used.

One of the most common plate formats is a 96-well assay plate, wherein the wells are arranged in a matrix having 8 lettered rows and 12 numbered columns. It should be understood that other plate formats are also commonly used, such as 384-well assay plates. Multi-well assay plates may be manually handled or handled by automated systems. Known automated systems include robotic devices for use in various procedures including thermal cycling of PCR reactions, luminometers, plate readers and the like.

Magnetic separation techniques are commonly used for the purification, quantification or identification of various substances. These techniques involve the suspension of magnetically attractable particles in a liquid that contains a substance of interest, typically in an impure or dilute form. The substance of interest is usually captured by the magnetically attractable particles and concentrated at a surface of the well containing the liquid through the application of a magnetic field to the well. After the substance of interest is concentrated against a surface of the well and while the magnetic field is still applied, the remaining liquid or supernatant can be discarded by using a pipetting device leaving a pellet of the substance of interest intact against the surface of the well. It should be noted that other methods of removing the supernatant may be employed, such as by pouring off the supernatant. If desired, additional liquid can then be added to the well and the magnetic field removed, thus allowing the particles to be resuspended in the liquid. The substance of interest can be recovered at any time by reapplying the magnetic field to the well and thereafter removing the supernatant. Thus, as generally understood, a typical magnetic separation technique usually includes an initial capture step, followed by one or more treatment or washing steps and a final recovery step of the substance of interest.

A problem common to many known magnetic separation systems is the difficulty encountered in attempting to completely remove the supernatant. Another problem common to many known magnetic separation systems is the loss of some of the particles of the substance of interest during the removal of the supernatant. Yet another problem common to many known magnetic separation systems concerns the efficiency and effectiveness of the treatment or washing steps.

### SUMMARY OF THE INVENTION

Accordingly, there is a need for an apparatus and method for use in magnetic separation of magnetically attractable particles in a liquid that addresses the aforementioned problems and other problems. Briefly, the present invention includes a plate for supporting a magnet (i.e., a magnetic separator plate) and for receiving a well containing a liquid having magnetically attractable particles suspended therein, such that when the magnetic separator plate receives the well, the magnet attracts the magnetically attractable particles suspended in the liquid contained within the well to create a pellet of such particles that may be attached to a substance of interest along a side wall or surface of the well.

In one embodiment of the present invention, the magnetic separator plate includes a plurality of elongated channels for receiving columns or rows of wells of a multi-well assay plate. Each channel includes a plurality of individual magnets which are placed along the same side wall of each well of the associated column or row of wells of the multi-well assay plate, such that each well is adjacent a magnetic field, and such that the magnetically attractable particles suspended in the liquid contained within the wells are drawn to the side walls of the wells and not to the bottom of the wells. Preferably, the magnets are arranged in each channel such that each magnet's North-South (N-S) pole axis is orientated in a horizontal plane that is substantially perpendicular to the wells of the multi-well assay plate and also substantially parallel with the magnetic separator plate in order to better maximize the magnetic field applied to each well. In addition, the arrangement of the N-S poles of each magnet in an associated channel is opposite to the N-S poles of an adjacent magnet in the same channel.

It is therefore a feature of the present invention to provide a magnetic separator plate which attracts magnetically attractable particles to a side wall of a liquid containing well to enhance the removal of a supernatant through the use of a pipetting device or other means without substantially removing any of the particles of the pellet of the substance of interest concentrated at the side wall of the well, and to also enhance the treatment or washing of the pellet of the substance of interest by optimizing the location of the pellet of the substance of interest along the side wall of the well.

It is also a feature of the present invention to provide a method of separating suspended magnetically attractable particles contained within a well by positioning a side wall of the well adjacent to at least one magnet supported by a magnetic separator plate.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is an exploded perspective view of a magnetic separation system utilizing a magnetic separator plate according to the present invention.

FIG. 2 is a partial top view, partially cut away, of the system of FIG. 1.

FIG. 3 is a cross-sectional view taken along line III-III of FIG. 2.

FIG. 4 is a partial top view of the magnetic separator plate of FIG. 1 illustratively showing the orientation of the N-S poles of adjacent magnets positioned in an associated channel of the magnetic separator plate.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting.

### DETAILED DESCRIPTION OF THE PREFERRED EMBODIMENT

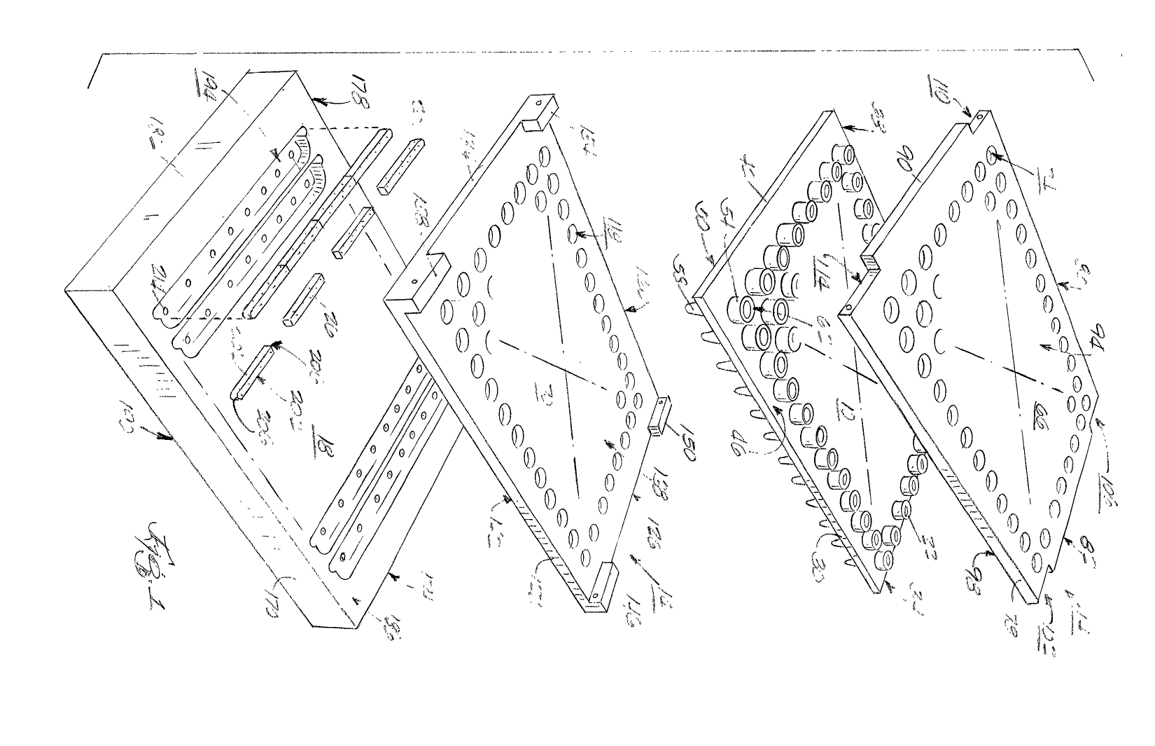

FIG. 1 illustrates a multi-well assay plate 10, a plate holder assembly 14 and a magnetic separator plate 18 for receiving the multi-well assay plate 10. As shown, the multi-well assay plate 10 includes a plurality of wells 22 arranged in an array of eight rows and twelve columns. Although not shown, it is common to label the rows A-H and the columns 1-12 in order to identify each well. For the purposes of this disclosure, columns could be considered rows and rows could be considered columns. It should be understood that the present invention is capable of use with other liquid containing wells and multi-well assay plates, and the multi-well assay plate 10 is merely shown and described as an example of one such multi-well assay plate. It should also be understood that the present invention is capable of use with other plate holder assemblies and the plate holder assembly 14 is merely shown and described as an example of one such assembly. In fact, the present invention is capable of use with various assay equipment and processes, and a plate holder assembly may not always be necessary. As will be further explained below, the magnetic separator plate 18 includes a plurality of magnets 26 for attracting magnetically attractable particles in a liquid contained within the wells 22 of the multi-assay plate 10, it being understood that the magnetic separator plate may include a single magnet or additional magnets as may be necessary given the arrangement of the liquid containing well or wells.

As illustratively shown in FIG. 1, the wells 22 are integrally formed with the plate 10 to create a single, one-piece multi-well plate 10, but the invention is capable of use with plate assemblies where the wells are not integrally formed with a plate. The plate 10 is preferably made of plastic, but can be made of other suitable materials. The plate 10 is substantially rectangular having a first side 30, a second side 34, a third side 38 and a fourth side 42, all of which extend between a top side 46 and a bottom side 50. The wells 22 extend through the top side 46 and the bottom side 50. Each well 22 includes an upper portion 54 which extends from the top side 46 of the plate 10 and a lower portion 58 which extends from the bottom side 50 of the plate 10. The upper portion 54 includes an opening 62 for receiving a fluid sample which is stored, analyzed or subjected to a reaction, in accordance with the desired procedure.

With continued reference to FIG. 1, the plate holder assembly 14 includes an upper plate holder 66 and a lower plate holder 70. The illustrated upper plate holder 66 and the illustrated lower plate holder 70 are substantially rectangular and flat. Preferably, the upper plate holder 66 and the lower plate holder 70 are made of a non-warping material, such as aluminum or a heat resistant plastic material, but may be made of other suitable material. Preferably the material of the plate holders 66 and 70 is stiffer than the material of the plate 10. The upper plate holder 66 has a plurality of openings 74, one for each well 22, a first side 78, a second side 82, a third side 86 and a fourth side 90, all of which extend between a top side 94 and a bottom side 98. Although not shown, the top side 94 may include labels in the form of letters and numbers in order to facilitate identification of the individual wells 22. The upper plate holder 66 further has a first L-shaped notch 102 extending between the first side 78 and the second side 82, a second L-shaped notch 106 extending between the second side 82 and the third side 86, a third L-shaped notch 110 extending between the third side 86 and the fourth side 90, and a fourth L-shaped notch 114 extending between the first side 78 and the fourth side 90. The lower plate holder 70 has a plurality of openings 118, one for each well 22, a first side 122, a second side 126, a third side 130 and a fourth side 134, all of which extend between a top side 138 and a bottom side 142. The lower plate holder 70 further has a first rectangular projection 146, a second rectangular projection 150, a third rectangular projection 154 and a fourth rectangular projection 158, all of which extend from the top side 138.

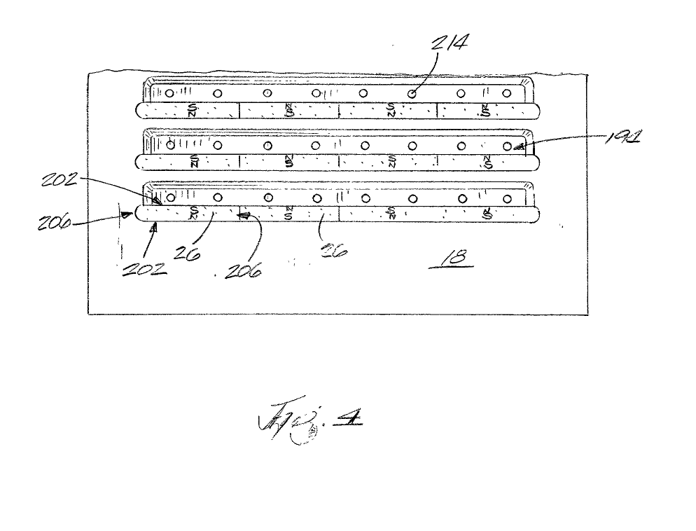

Although not clearly shown in FIG. 1, but with reference to FIG. 3, each notch 102, 106, 110 and 114 of the upper plate holder 66 includes a detent 162 and each projection 146, 150, 154 and 158 of the lower plate holder 70 includes a detent receiving hole or bore 166. FIG. 3 representatively illustrates the cooperation between the detents 162 and the detent receiving holes 166.

The plate holder assembly 14 operates as follows. The upper plate holder 66 is releasably engaged with the lower plate holder 70 to sandwich and hold the multi-well assay plate 10 therebetween. The plurality of openings 74 of the upper plate holder 66 align with and receive the upper portions 54 of the wells 22, and the plurality of openings 118 of the lower plate holder 70 align with and receive the lower portions 58 of the wells 22. So as to allow for the proper use of the wells 22 during certain laboratory and clinical procedures, the upper portions 54 of the wells 22 extend beyond the top side 94 of the upper plate holder 66 and the lower portions 58 extend beyond the bottom side 142 of the lower plate holder 70 (see FIG. 3). The bottom side 98 of the upper plate holder 66 engages the top side 46 of the plate 10 and the top side 138 of the lower plate holder 70 engages the bottom side 50 of the plate 10. Notches 102, 106, 110 and 114 of the upper plate holder 66 receive the projection members 146, 150, 154 and 158 of the lower plate holder 70, respectively. The detents 162 of the upper plate holder 66 are received by the associated detent receiving holes 166 of the lower plate holder 70 to hold the upper plate holder 66 to the lower plate holder 70. So assembled, the multi-well assay plate 10 is more easily handled, as compared to a plate standing by itself. To release the upper plate holder 66 from the lower plate holder 70, a force is simply applied to the tops of the projection member 146, 150, 154 and 158 to separate the detents 162 from the detent receiving holes 166.

The multi-well assay plate 10 and plate holder assembly 14 thus far described is more fully disclosed in co-pending U.S. application Ser. No. 09/676,184 filed on Sep. 29, 2000 and entitled “Multi-Well Assay Plate and Plate Holder and Method of Assembling the Same”, which is incorporated herein by reference in its entirety. Having described the structure of the plate 10 and plate holder assembly 14, the structure and operation of the magnetic separator plate 18 in combination with the plate 10 and plate holder 14 will now be more fully explained.

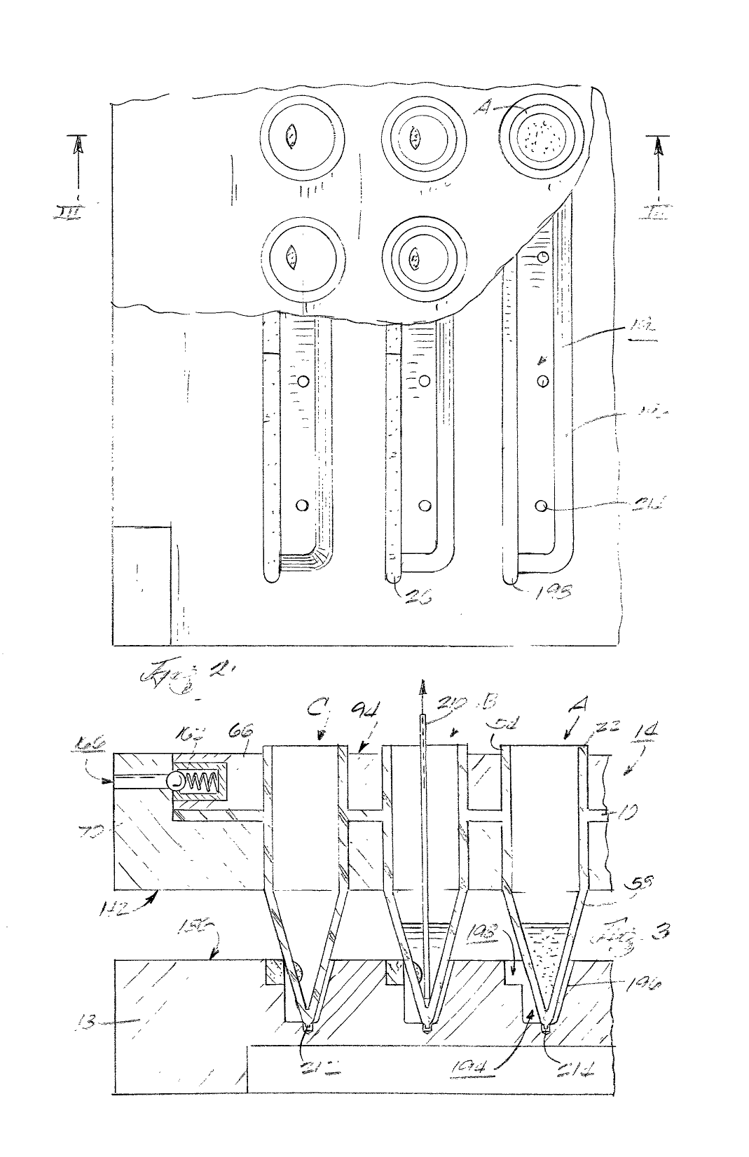

With reference to FIG. 1, the magnetic separator plate 18 is substantially rectangular having a first side 170, a second side 174, a third side 178 and a fourth side 182, all of which extend between a top side 186 and a bottom side 190. Preferably, the separator plate 18 is made of a non-warping, chemical resistant material, such as aluminum, but may be made of other suitable materials. The separator plate 18 includes a plurality of elongated channels 194, one for each column of wells 22 of the plate 10. At least one elongated side 196 of each channel 194 is beveled (see FIGS. 2 and 3) to assist in guiding the wells 22 of the plate 10 into the associated channel 194 of the separator plate 18. Each channel 194 further includes or at least partially defines an elongated, substantially “L” shaped recess 198 (see FIG. 3) extending from the top side 186 of the separator plate 18 for receiving a plurality of magnets 26 (see FIG. 1). Preferably, each recess 198 is located on the same side of each channel 194 as shown in FIGS. 1-4 and, therefore, on the same side of each well 22. As shown in FIGS. 1 and 4, each recess 198 receives four magnets 26, although one or more magnets may be utilized. The magnets 26 are preferably rectangular, each having opposite sides 202 and opposite ends 206 (FIG. 1). The magnets 26 can be fabricated from many different materials and have varying strengths, depending on the desired application, as can be appreciated by those skilled in the art. However, a 30, preferably 35, mGauss orsted neodymium iron boron magnet is suitable for use according to the principles of the present invention. Moreover, the N-S poles of the magnets 26 are preferably located at the sides 202 (see FIG. 4), as compared to the ends 206. In this manner, with reference to FIG. 4 in combination with FIGS. 1 and 3, each magnet's N-S pole axis is orientated in a horizontal plane which is substantially perpendicular to the wells 22 of the multi-well plate 10 and which is also substantially parallel with the top side 186 of the magnetic separator plate 18 in order to maximize the magnetic field applied to each well 22. In addition, as shown in FIG. 4, the arrangement of the N-S poles of each magnet 26 in a respective channel 194 is opposite to the arrangement of the N-S poles of an adjacent magnet 26 in the same channel 194 for enhanced operation. As shown in FIG. 4 in combination with FIG. 1, for every two wells 22 in a column of wells 22, there is provided an individual magnet 26. As will be more fully explained below, each magnet 26 operates to attract magnetically attractive particles in a liquid found in the associated pair of wells 22 positioned substantially adjacent thereto. To further increase the force and magnetic field applied to each well 22, an individual magnet 26 for each well 22 could be placed in the associated recess 198 or channel 194. The magnets 26 can be held within the associated recess 198 according to any number of acceptable methods, such as by friction, but securing the magnets 26 to the sides or walls of the associated recess 198 with an appropriate adhesive or glue is suitable according to the principles of the present invention.

Having described most of the components of the assembly shown in FIG. 1, the overall magnetic separation process utilizing the magnetic separator plate 18 of the present invention will now be described.

The upper plate holder 66 is engaged with the lower plate holder 70 to sandwich and hold the multi-well plate 10 therebetween as more fully described above. A liquid having a suspension of magnetically attractable particles therein is put into the desired wells 22. Such a liquid is representatively shown in well “A” of FIGS. 2 and 3. The recess 198 of the channel 194 associated with well “A” is shown in FIGS. 2 and 3 without its magnets 26 for illustrative purposes. After the magnets 26 attract the magnetically attractable particles against a side wall of the associated well 22 (see well “B” in FIG. 3 as an illustration), the supernatant is pipetted out of the well 22 using a pipetting device 210 as shown in FIG. 3. Thereafter, only the pellet of the substance of interest remains, as such is illustratively shown in well “C” of FIG. 3. It should be understood that a pellet refers to a concentration of particles that is higher than that free in solution. Because the pellet of material is located at a side wall of the associated well 22, the pipetting device is able to substantially remove all of the supernatant without substantially removing any of the particles of the pellet (see FIG. 3). If it is desired to treat or wash the pellet, the magnet 26 is located at a height along the side wall of the associated well 22 to ensure that the entire pellet is covered by the liquid returned to the well 22 after the supernatant has been removed. Preferably, with reference to FIG. 3, at least a portion of each magnet 26 comes into contact with an outer surface of the adjacent well 22 to ensure that the greatest magnetic field is applied to the well 22 and to further support the plate 10 as it is received by the separator plate 18.

The present invention includes an additional feature which is particularly beneficial when using an injected molded, plastic multi-well assay plate, such as plate 10. As known in the art, a sprue 212 (see FIG. 3) may be formed on the bottom of each well 22, of an injected molded, multi-well plate, like plate 10. During the magnetic separation technique as described above, the magnetic separator plate 18 is usually placed upon a flat surface, so as to best be able to receive and support the plate 10 and plate holder assembly 14 if utilized. Each channel 194 of the magnetic separator plate 18 includes a plurality of recesses, holes, bores, dimples or the like 214 (see FIGS. 1-4) adapted to receive an associated sprue 212 of each well 22. In this way, the magnetic separator 18 will receive the plate 10 so that the plate 10 is substantially flat with respect to the separator plate 18. Without the dimples 214 to receive the sprues 212, the plate 10 may not sit flat with respect to the separator plate 18 on account of the unpredictable overall shape and size of each sprue 212, which could adversely affect the results of the magnetic separation procedure as described herein, and as generally understood by those skilled in the art.

Variations and modifications are within the scope of the present invention. It is understood that the invention disclosed and defined herein extends to alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. An apparatus for use in magnetic separation of magnetically attractable particles suspended in a liquid, said apparatus comprising:
a magnetic separator plate having a top side and a bottom side and a channel extending therebetween for receiving a well containing the liquid and magnetically attractable particles suspended therein; and
a magnet embedded within said channel, such that when said magnetic separator plate receives the well, said magnet attracts the magnetically attractable particles in the liquid to create a pellet of material along a surface within the well.

2. An apparatus according to claim 1, wherein said magnet attracts the magnetically attractable particles in the liquid to create a pellet of material along a side wall within the well.

3. An apparatus according to claim 1, wherein at least one side wall of said channel is beveled to assist in guiding the well into said channel.

4. An apparatus according to claim 1, wherein said magnetic separator plate includes a recess which is at least partially defined by said channel and which has a generally “L” shaped border extending inward from said top side of said separator plate, said recess configured to receive said magnet.

5. An apparatus according to claim 1, wherein at least a portion of said magnet comes into contact with an outer side wall of the well to enhance the magnetic field applied to the well and to further support the well when received by said separator plate.

6. An apparatus according to claim 1, wherein a bottom portion of said channel is adapted to receive a sprue which may be formed on a bottom of the well.

7. An apparatus for use in magnetic separation of magnetically attractable particles suspended in a liquid, said apparatus comprising:
a magnetic separator plate for receiving a well containing the liquid and magnetically attractable particles suspended therein; and
a magnet supported by said separator plate, wherein said magnet includes a N-S polar axis, such that when said separator plate receives the well, said N-S polar axis of said magnet is orientated in a horizontal plane which is generally perpendicular to the well, and said magnet attracts the magnetically attractable particles in the liquid to create a pellet of material along a side wall within the well.

8. An apparatus according to claim 7, further comprising a second magnet which is supported by said separator plate, wherein said second magnet includes a N-S polar axis which is also orientated in a horizontal plane which is generally perpendicular to the well when said separator plate receives the well, said second magnet being positioned adjacent to the first magnet so that N-S poles of said second magnet are reversed with respect to N-S poles of said first magnet.

9. An apparatus for use in magnetic separation of magnetically attractable particles suspended in a liquid, said apparatus comprising:
a magnetic separator plate for receiving a plurality of wells arranged in at least one column, said magnetic separator plate including at least one elongated channel, one for each column of multiple wells, each channel at least partially defining an elongated recess extending from a top side of said magnetic separator plate; and
at least one magnet positioned in each recess, each magnet including N-S poles located on opposite sides thereof, such that each N-S polar axis of each magnet is orientated in a horizontal plane which is generally perpendicular to the wells when said separator plate receives the wells, so that said magnets attract the magnetically attractable particles in the liquid to create pellets of material along side walls within the wells.

10. An apparatus according to claim 9, wherein at least one side wall of each of said channels is beveled to assist in guiding the associated wells into the associated channel.

11. An apparatus according to claim 9, wherein each recess is generally “L” shaped, and each magnet is secured within the associated recess with an adhesive.

12. An apparatus according to claim 9, wherein at least a portion of each magnet comes into contact with an outer side wall of the associated well to enhance the magnetic field applied to the well and to further support the wells when received by said separator plate.

13. An apparatus according to claim 9, wherein a bottom portion of each channel is adapted to receive a sprue which may be formed on a bottom of each of the wells.

14. An assembly used for magnetically separating magnetically attractable particles suspended in a liquid, said assembly comprising:
a multi-well assay plate having a plurality of vertically extending wells;
a plate holder for receiving and supporting said multi-well assay plate, wherein at least a portion of each well extends below a bottom surface of said plate holder;
a magnetic separator plate for receiving at least a portion of each well which extends below said bottom surface of said plate holder; and
a plurality of magnets supported by said magnetic separator plate, such that when said magnetic separator plate receives said assay plate, said magnets attract the magnetically attractable particles in the liquid to create pellets of materials along side walls within said wells.

15. A method of magnetically separating magnetically attractable particles suspended in a liquid comprising the steps of:
providing a well which contains the liquid and magnetically attractable particles suspended therein;
supporting a magnet in a channel formed in a magnetic separator plate; and
positioning the well in the channel of the magnetic separator plate so that the magnet attracts the magnetically attractable particles in the liquid to create a pellet of material along a side wall within the well.

16. A method according to claim 15, wherein said step of positioning said well in the channel of the magnetic separator includes guiding the well into the channel by way of an automated device.
